(19) United States
(12) Patent Application Publication
(10) Pub. No.: US 2008/0068824 A1
(43) Pub. Date: Mar. 20, 2008

(54) EYEGLASSES WITH LIGHTING DEVICE

(76) Inventor: Ching-Hsiang Wang, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/533,701

(22) Filed: Sep. 20, 2006

(51) Int. Cl. F21V 21/08

(52) U.S. Cl. 362/103

(57) ABSTRACT

A pair of eyeglasses with a lighting device is provided. The lighting device is disposed across a temple pivotally connected to an eyeglass frame and consists of a clip and a light apparatus. A fasterning button of the light apparatus is tightly fastened to a socket of the clip. The socket is provided with blocking members to prevent the fasterning button from loosening. The clip further has a gap and a side having a lower end curved upwardly to increase flexibility to faciliate deformation. The deformation allows the clip to be pressed down easily onto the temple so that the clip is stably positioned. As a result, a user can adjust the light apparatus at any angle desired, then press a switch button of the light apparatus to connect/disconnect power supply. Simple and easy operation is thus achieved to turn on said lighting apparatus to lighten a place lack of lights.

### FIELD OF THE INVENTION

The present invention relates to eyeglasses with a lighting device; in particular, the present invention relates to eyeglasses having a lighting device disposed tightly across a temple thereof so that when in places lack of lights or when at night, a user can utilize the lighting device and adjust it with different angles to have a clear line of sight.

### BACKGROUND OF THE INVENTION

Conventionally, most eyeglasses are manufactured to enhance their esthetic appearance. They are designed with a variety of shapes and forms so as to enrich the overall esthetics. Unfortunately, no other functions or values are created. When most people are in a place lack of lights or when it's at night, they will mostly utilize a flashlight for lightening purpose if they were to see things clearly or to be able to perform some tasks. However, it is inconvenient to carry a flashlight. Therefore, some suppliers combined the lighting method of a hard hat with the eyeglasses and developed some lighting devices. For example, a switch of a lighting device is disposed inside an eyeglass frame, while a battery and circuit board are provided on an eyeglass temple; alternatively, a lighting device is engaged with a positioning base, and then the positioning base is screwed onto an eyeglass temple.

### SUMMARY OF THE INVENTION

The inventor therefore developed eyeglasses with a lighting device, maintaining the originally effect, while improving the usability so that the lighting device can be quickly positioned and assembled/detached. As a result, the user can obtain great lighting effect from different angles along his line of sight.

An object of the present invention is to provide a pair of eyeglasses with a lighting device. The lighting device is disposed across a temple pivotally connected to an eyeglass frame and consists of a clip and a light apparatus. A fasterning button of the light apparatus is tightly fastened to a socket of the clip. The socket is provided with blocking members to prevent the fasterning button from loosening. The clip further has a gap and a side having a lower end curved upwardly to increase flexibility to faciliate deformation. The deformation allows the clip to be pressed down easily onto the temple so that the clip is stably positioned. As a result, a user can adjust the light apparatus at any angle desired, then press a switch button of the light apparatus to connect/disconnect power supply. Simple and easy operation is thus achieved to turn on said lighting apparatus to lighten a place lack of lights.

### BRIEF DESCRIPTION OF THE DRAWINGS

FIG. 1 is an exploded perspective view of a pair of eyeglasses with a lighting device according to the present invention;

FIG. 2 illustrates the lighting device according to the present invention assembled to the eyeglasses;

FIG. 3 is a side view of the eyeglasses with a lighting device according to the present invention;

FIG. 4 is a schematic view showing angle adjustment of the eyeglasses with a lighting device according to the present invention; and

FIG. 5 is a top view of the eyeglasses with a lighting device according to the present invention.

### DETAILED DESCRIPTION OF THE EMBODIMENTS

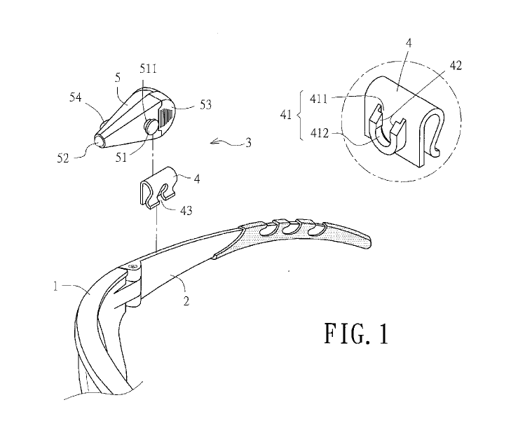

Referring to FIG.1 , a pair of eyeglasses with a lighting device 3 according to the present invention are shown. The lighting device 3 is disposed across a temple 2 pivotally connected to a side of a frame 1. The lighting device 3 consists of a clip 4 and a light apparatus 5 engaged with the clip 4 for positioning purpose.

The clip 4 is formed of flexible material and has a generally “R” cross-sectional shape so that the clip 4 has a flat side and a curved side having a lower end curved upwardly. A U-shaped socket 41 is formed on the flat side of the clip 4. The U-shaped socket 41 has a first inner space 411 and a second outer space 412. The first space 411 is wider than the second space 412 and there is a discrepancy between the first space 411 and the second space 412. A blocking member 42 extends from an upper section of each side of the U-shaped socket 41. The clip 4 further has a gap 43 at a center portion of the curved side.

The light apparatus 5 is provided with a luminous element having a luminary 52 inside, powered by a battery electrically connected thereto. The light apparatus 5 is further provided with a battery cover 53 and a fastening button 51 on one side and, on an opposite side, a switch button 54 electrically connected to the luminous element. The fastening button 51 is formed with a groove on its outer surface to form a narrower section 511. The diameter of the narrower section 511 of the fastening button 51 is equal to the diameter of the second space 412 of the socket 41 of the clip 4 and the length of the narrower section 511 is equal to the depth of the second space 412 of the socket 41.

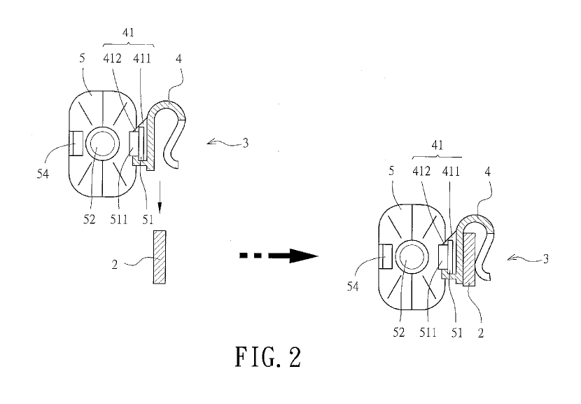

In assembly, please refer to FIG. 2. The fastening button 51 and the narrower section 511 of the light apparatus 5 are tightly engaged with the first space 411 and the second space 412 of the socket 41 of the clip 4 for positioning purpose. The clip 4 is deformable by providing the gap 43 and the curved side wall of the clip 4 so as to increase flexibility of the clip 4. Hereby, the clip 4 can be easily pressed down and stably positioned across the temple 2.

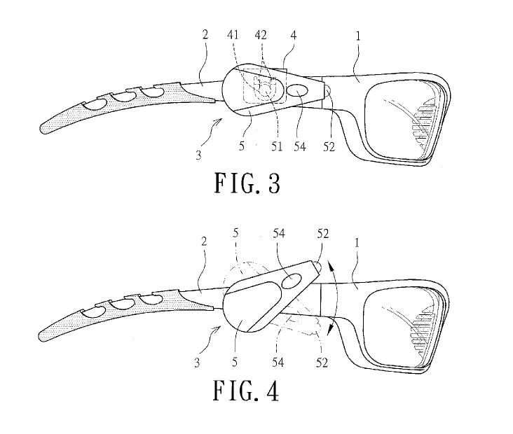

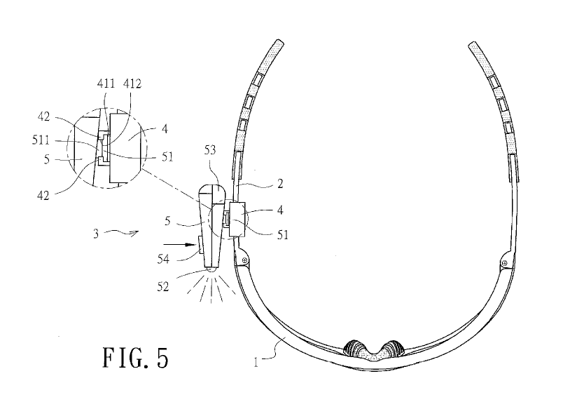

In use, refer to FIGS. 3, 4 and 5. The fastening button 51 of the light apparatus 5 in the socket 41 of the clip 4 is adjustable at any angle as desired. The blocking members 42 of the clip 4 can prevent the fastening button 51 and the narrower section 511 from loosening. The switch button 54 of the light apparatus 5 can be pressed to connect power supply so as to turn on the luminous element 52 of the lighting device 3 to lighten the place lack of lights. Moreover, when the light is no longer required, the switch button 54 can be pressed again to disconnect power supply.

What is claimed is:

1. Eyeglasses with a lighting device, comprising a lighting device provided across a temple pivotally connected to a side of a glass frame, characterized in that:
said lighting device consists of a clip and a light apparatus tightly combined with one another for positioning purpose, wherein said clip is formed with a socket on one side, a blocking member extends from an upper section of each side of the socket, a luminous element having a luminary is provided inside said light apparatus, and a fastening button and a pressable switch button are provided on both sides of said light apparatus respectively;
hereby said light apparatus is adjustable at a desired angle, and press said switch button of said light apparatus will connect/disconnect power supply so as to turn on said luminous element to lighten a place lack of lights.

2. The eyeglasses with a lighting device according to claim 1, wherein said clip is formed of flexible material and has a generally “R” cross-sectional shape.

3. The eyeglasses with a lighting device according to claim 1, wherein a lower end of one side of said clip is curved upwardly to facilate deformation of the clip so that the clip can be easily pressed downwardly and then disposed across the temple for stable positioning purpose.

4. The eyeglasses with a lighting device according to claim 1, wherein said clip is provided with a gap on a center protion of one side to increase flexiblity.

5. The eyeglasses with a lighting device according to claim 1, wherein the socket of the clip is substantially U shaped and has a first inner space and a second outer space with the first space being wider than the second space and there being a discrepancy between the first space and the second space.

6. The eyeglasses with a lighting device according to claim 1, wherein said fastening button can be provided with a groove on its outer surface so as to form a narrower section, with the diameter of the narrower section being equal to the diameter of the second space of the socket of the clip and the length of the narrower section being equal to the depth of the second space of the socket.

7. The eyeglasses with a lighting device according to claim 1, wherein a battery is electrically connected to the luminous element of the light apparatus to serve as a power source, and a battery cover is provided on one side of said light apparatus.
